(19) United States
(12) Patent Application Publication
(10) Pub. No.: US 2018/0315341 A1
(43) Pub. Date: Nov. 1, 2018

(54) VIRTUAL STOCK MARKET ENVIRONMENT

(71) Applicant: Bluechxp, LLC, Chicago, IL (US)

(72) Inventors: Michael Patak, Chicago, IL (US); Andre McHugh, Chicago, IL (US); Melissa Footlick, Chicago, IL (US); Jay Rudman, Chicago, IL (US)

(21) Appl. No.: 15/883,490

(22) Filed: Jan. 30, 2018

Related U.S. Application Data
(60) Provisional application No. 62/452,303, filed on Jan. 30, 2017.

(51) Int. Cl. G09B 19/18; G06Q 40/04; G09B 9/00; G09B 5/02; A63F 13/85; A63F 13/822

(52) U.S. Cl. CPC G09B 19/18; G06Q 40/04; G09B 9/00; A63F 2300/8094; A63F 13/85; A63F 13/822; G09B 5/02

(57) ABSTRACT

Systems and methods include generating a virtual stock market environment that mirrors an actual stock market in real-time. Embodiments relate to engaging the user selection into the virtual stock market environment to expose the user selection to a fluctuation of the virtual stock market environment that mirrors the actual stock market in real-time. Raw stock market data that is aggregated from the actual stock market in real-time is incorporated into the virtual stock market environment. The raw stock market data is an actual representation of the actual value of the actual stock pick in the actual stock market in real-time. The virtual stock value of the user selection is determined in real-time in the virtual stock market environment based on the raw stock market data aggregated from the actual stock market as the raw stock market data fluctuates in real-time relative to the actual stock market fluctuating in real-time.

### CROSS-REFERENCE TO RELATED APPLICATIONS

This application is a U.S. Nonprovisional Application which claims the benefit of U.S. Provisional Application No. 62/452,303, filed Jan. 30, 2017, which is incorporated herein by reference in its entirety.

### BACKGROUND

Conventional participation in the actual stock market requires a user to invest their own funds in acquiring actual stock picks. Depending on the stock market knowledge of the user as well as the volatile fluctuation of the actual stock market, the user may find that the actual value of their actual stock picks may decrease and may decrease significantly such that the value of the actual stock picks is worth significantly less than the initial value of the actual stock that the user initially purchased the actual stock. Thus, an inexperienced user may suffer significant financial loss in engaging in the actual stock market due to the user selection actual stock picks that fall in value.

Even with significant experience, financial risk is assumed by the user with each time that the user engages the actual stock market with the acquisition of an actual stock pick. Many users may not have the financial resources available to assume the financial risk of engaging the actual stock market and thereby fail to gain the necessary experience to engage the actual stock market to obtain financial gain with their actual stock picks. Thus, many inexperienced users may be deterred from engaging the actual stock market and fail to gain the necessary experience to increase their likelihood to obtain financial gain by engaging the actual stock market. A virtual stock market environment that mirrors the actual market and provides the user feedback for their selections that mirrors the results of the actual stock market may provide the user with the opportunity improve their skill in the actual stock market without assuming the financial risk of actually engaging the actual stock market.

### BRIEF SUMMARY

Embodiments of the present disclosure relate to generating a virtual stock market environment that mirrors the actual stock market where the raw stock market data is aggregated in real-time from the actual stock market and incorporated into the virtual stock market environment such user selections in the virtual stock market environment fluctuate in real-time relative to the actual stock market fluctuating in real-time. A system may be implemented to generate a virtual stock market environment that mirrors an actual stock market in real-time that corresponds to a user selection and provides real-time feedback to an engagement of a user in the virtual stock market environment. The system includes at least one processor and a memory coupled with the processor. The memory includes instructions that when executed by the processor cause the processor to receive the user selection that corresponds to an actual stock pick that is available in the actual stock market that the user requests to enter into the virtual stock market environment.

The processor is configured to assess a virtual stock value for the user selection that incorporates a real-time assessment of an actual value of the actual stock pick that corresponds to the user selection as determined from the actual stock market. The processor is configured to engage the user selection into the virtual stock market environment to expose the user selection to a fluctuation of the virtual stock market environment that mirrors the actual stock market in real-time. The processor is configured to incorporate raw stock market data aggregated from the actual stock market in real-time into the virtual stock market environment. The raw stock market data is an actual representation of the actual value of the actual stock pick in the actual stock market in real-time. The processor is configured to determine the virtual stock value of the user selection in real-time in the virtual stock market environment based on the raw stock market data aggregated from the actual stock market as the raw stock market data fluctuates in real-time relative to the actual stock market fluctuating in real-time.

In an embodiment, a method generates a virtual stock market environment that mirrors an actual stock market in real-time that corresponds to a user selection and provides real-time feedback to an engagement of a user in a virtual stock market environment. The user selection may be received that corresponds to an actual stock pick that is available in the actual stock market that the user requests to enter into the virtual stock market environment. A virtual stock value may be assessed for the user selection that incorporates a real-time assessment of an actual value of the actual stock pick that corresponds to the user selection as determined from the actual stock market. The user selection may be engaged into the virtual stock market environment to expose the user selection to a fluctuation of the virtual stock market environment that mirrors the actual stock market in real-time. The raw stock market data that is aggregated rom the actual stock market in real-time may be incorporated into the virtual stock market environment. The raw stock market data is an actual representation of the actual value of the actual stock market in real-time. The virtual stock value of the user selection may be determined in real-time in the virtual stock market environment based on the raw stock market data aggregated from the actual stock market as the raw stock market fluctuates in real-time relative to the actual stock market fluctuating in real-time.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 shows an illustration of a system for a simulated training and gaming environment;

FIG. 2A is a flowchart showing an example method for providing a simulated training and gaming environment;

FIG. 2B is a flowchart showing an example method for providing a simulated training and gaming environment;

FIG. 2C is a flowchart showing an example method for providing a simulated training and gaming environment;

FIG. 3 is a flowchart showing an example method for providing a simulated training and gaming environment;

FIG. 4 is a flowchart showing an example method for providing a simulated training and gaming environment;

FIG. 5 is an example system for providing a simulated training and gaming environment that includes a wireframe template for a client device application for the system;

FIG. 6A is an example system for providing a simulated training and gaming environment that includes a graphical user interface for a display of a client for the system;

FIG. 6B is an example system for providing a simulated training and gaming environment that includes a graphical user interface for a display of a client for the system;

FIG. 6C is an example system for providing a simulated training and gaming environment that includes a graphical user interface for a display of a client for the system;

FIG. 6D is an example system for providing a simulated training and gaming environment that includes a graphical user interface for a display of a client for the system;

FIG. 6E is an example system for providing a simulated training and gaming environment that includes a graphical user interface for a display of a client for the system;

FIG. 6F is an example system for providing a simulated training and gaming environment that includes a graphical user interface for a display of a client for the system;

FIG. 6H is an example system for providing a simulated training and gaming environment that includes a graphical user interface for a display of a client for the system; and

FIG. 6G is an example system for providing a simulated training and gaming environment that includes a graphical user interface for a display of a client for the system.

### DETAILED DESCRIPTION

Embodiments of the disclosure generally relate to generating a virtual stock market environment. In an example embodiment, a virtual stock market environment is generated that mirrors an actual stock market in real-time. The virtual stock market environment provides real-time feedback to the user regarding user selections such that the real-time feedback mirrors in real-time how the user selections would have fared had the user made the selections as actual stock picks in the actual stock market. Raw stock market data for the user selections is aggregated from the actual stock market in real-time into the virtual stock market environment. The raw stock market data is an actual representation of the actual value of the actual stock picks that mirror the user selections in the virtual stock market environment. Thus, as the raw stock market data is aggregated in real-time, the user selections fluctuate in real-time in the virtual stock market environment similar to as if the user had made the selections as actual stock picks in the actual stock market without having to assume the financial risk of doing so.

In the Detailed Description herein, references to “one embodiment”, an “embodiment”, and “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in art to affect such feature, structure, or characteristic in connection with other embodiments whether or not explicitly described.

The following Detailed Description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the Detailed Description is not meant to limit the embodiments described below.

### System Architecture

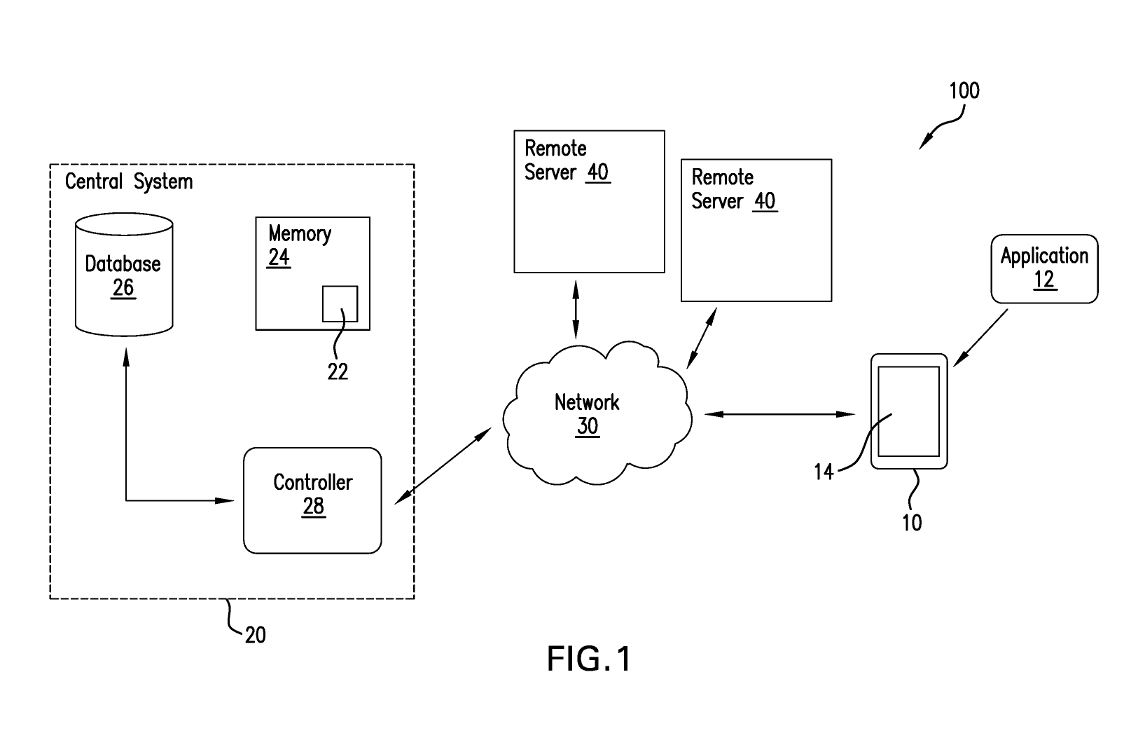

A simulated stock market training and gaming environment is configured and operated using various hardware and/or software components. FIG. 1 illustrates one example system for a simulated training and gaming environment according to the teachings of the present disclosure. The depicted computing system 100 includes a central system 20, remote servers 40, a network 30, and a client device 10. Alternative and/or additional embodiments of the computing system 100 may include one or more of each of the illustrated components or a combination thereof. Some embodiments may include fewer components. For example, computing system 100 may include multiple client devices 10, multiple networks 30, multiple systems 20, and a single remote server 40.

In some embodiments, the functions of multiple components may be successfully performed by one of the illustrated components. The computing system 100 may include directly coupled components that communicate without an intervening network. Any one or more individual components, such as central system 20 may be housed in a single physical device or may be configured to exploit distributed processes or cloud computing. The computing system 100 may be fully described from the perspective of one or more individual components. Client device 10, central system 20, and remote server 40 are communicatively coupled via one or more networks 30. Each of these components is discussed in turn, below. The term “real-time” as used herein encompasses its plain and ordinary meaning, including, but not limited to the timing of events occurring with an immediacy that is virtually concurrent with actual time, or occurring within one second or less of the actual time.

### Central System

The central system 20 may be a server and may include one or more software instruction sets 22, one or more memory devices 24, one or more databases 26, and one or more controller 28. The term “server” collectively includes the components of central system 20 for creating, maintaining, and updating database 26. The term “database” as used herein refers to a storage medium and is not necessarily limited to any specific relational organization requirements, except where explicitly specified. The central system 20 may include one or more workstations (not illustrated). Software instructions 22 may be stored in memory 24 or may be stored in database 26 and executed by a controller 28. Controller 28 may be in communication with client devices 10 via the network 30.

Central system 20 may acquire, create, maintain and/or obtain databases including virtual stock market data, virtual stock data, actual stock market data, user account information, software instruction sets configured to executing all aspects of game play, historical user performance data, and historical data that are associated with the simulated game/training environment. Central system 20 may also store master copies and updates of computer programs that may be downloaded on a client device as an application, standalone program, module, script, code, subroutine, or combinations thereof. Central system 20 may also be a host for a website or web service providing the simulated gaming and/or training services provided herein.

Central system 20 may obtain raw stock market data originating from or stored on one or more remote servers 40. Raw stock market data includes current stock market and/or exchange information, data associated with individual stocks, and substantially real time values of individual stocks, bonds, funds, and/or indexes. Raw stock market data obtained from remote servers 40 may be received by central system 20 and stored in one or more databases 26. Additional stock market or exchange data may be acquired by central system 20 from other sources, via network 30 or via a workstation coupled to central system 20. One or more sets of software instructions that are executed by the central system 20 may include algorithms gathering and interpreting raw stock market data from one or more remote servers 40 to use as a basis for determining values and characteristics of virtual stocks in the simulation environment. The raw stock data received by the central system from remote servers 40 may be stored in one or more pricing database of the central system. The pricing database may store multiple values for each stock historically. Alternatively, a limited number of values for each virtual stock may be stored in the pricing database. For example, the central system may store one month's worth of the most recently obtained raw stock data for each virtual stock.

Central system 20 may further receive selected stock picks from one or more client devices 10 and automatically perform a corresponding real-world trade based on the received stock pick. The central system 20 may conduct a real world purchase via network 30 in conjunction with one or more remote server 40.

### Remote Server

Remote Server 40 may be a server including similar computing components as those described with respect to central system 20. Remote server 40 may be owned and operated by one or more third parties and provide valuation information of stocks, bonds, and securities traded on one or more stock market exchanges. The third party may provide access to data originating and/or stored on remote server 40 via an application programming interface (API). Central system 20 and other entities may thus obtain the raw stock market data stored on remote server 40. Real time or substantially real time values for stocks on one or more exchanges may be acquired from remote server 40.

### Client Device

Client device 10 includes client device application 12 and interactive display 14. Client device 10 may also include a processor, memory, communication interface and other components that are not illustrated. Client device 10 may be a mobile device, smartphone, tablet computer, personal computer, laptop, set top box, or other computing device. The client device application 12 may be one or more sets of software instructions executed by the client device 10 to provide user notification and/or user interaction with the simulated training and gaming environment. The client devices 10 need not store complete copies of the pricing database stored at the central system 20. Instead, the client device 10 may selectively query the central system to obtain virtual stock information relevant to the activities relevant to the user of the client device 10 via a client facing API.

Client device application 12 may be one or more computer programs that may be downloaded on a client device as an application, standalone program, module, script, code, subroutine, or combinations thereof. The application 12 may be downloaded to the client device 10 from central system 20. Updates to the application 12 may further be stored on central system 20 for access by the client device 10. The application 12 may include instructions causing client device 10 to execute instructions stored elsewhere on the client device 10 or stored remotely and accessed via network 30. Alternatively, or additionally, client device 10 may include a Web browser through which a user may use services hosted by central system 20.

The client device 10 may further perform some acts independent of the central system 20 in some embodiments. For example, the client device 10 may receive selected stock picks from the user and automatically perform a corresponding real-world trade based on the received stock pick. The client device 10 may conduct such a real world purchase via network 30 in conjunction with one or more remote servers 40. The client device may communicate the user selection and real world trade to central system 20, either simultaneously or at a later time.

The user of client device 10 may interact with the application 12 through display 14. The display 14 may be a touch graphical user interface display capable of displaying output and receiving user input via user contact and/or interaction with the surface of display 14. Alternative and additional input and output devices such as microphones, speakers, keyboards, stylus, mouse, or joysticks may serve as input and output devices accessed and used by application 12. Input and/or output devices may be physically integrated with client device 10 or connectively coupled to client device 10.

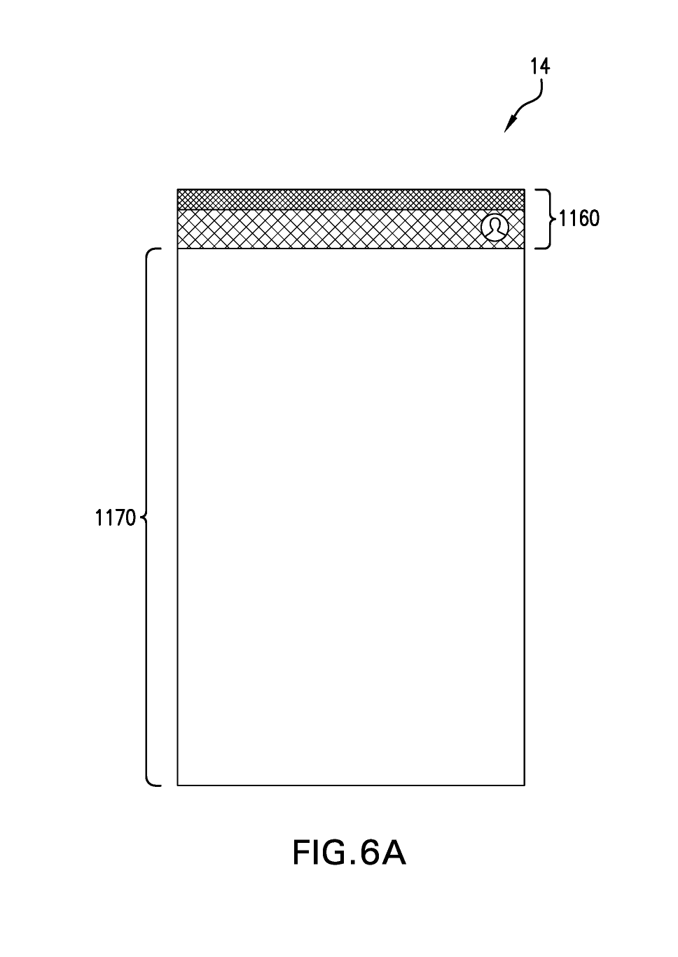

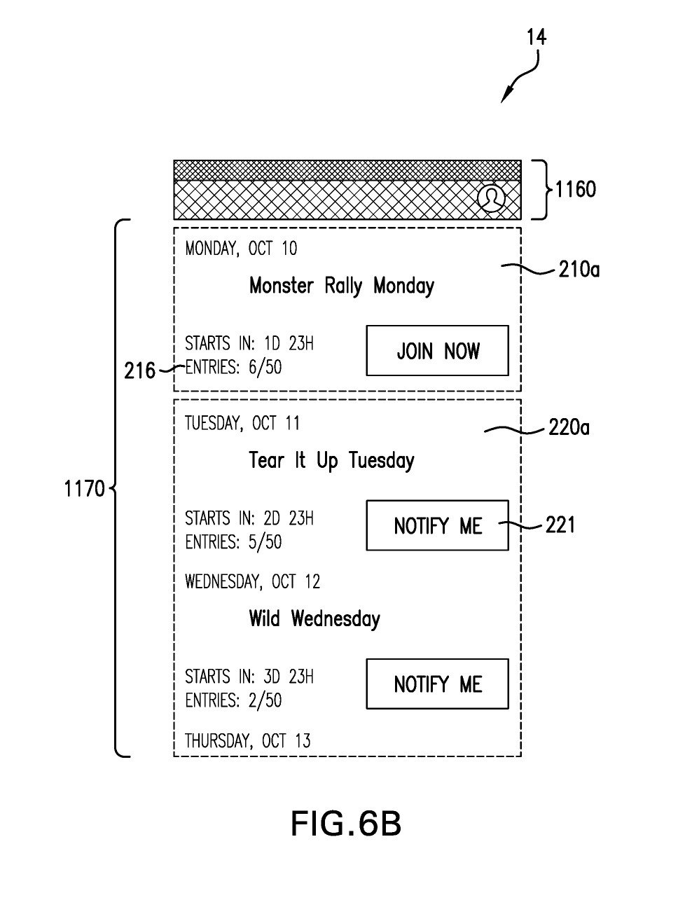

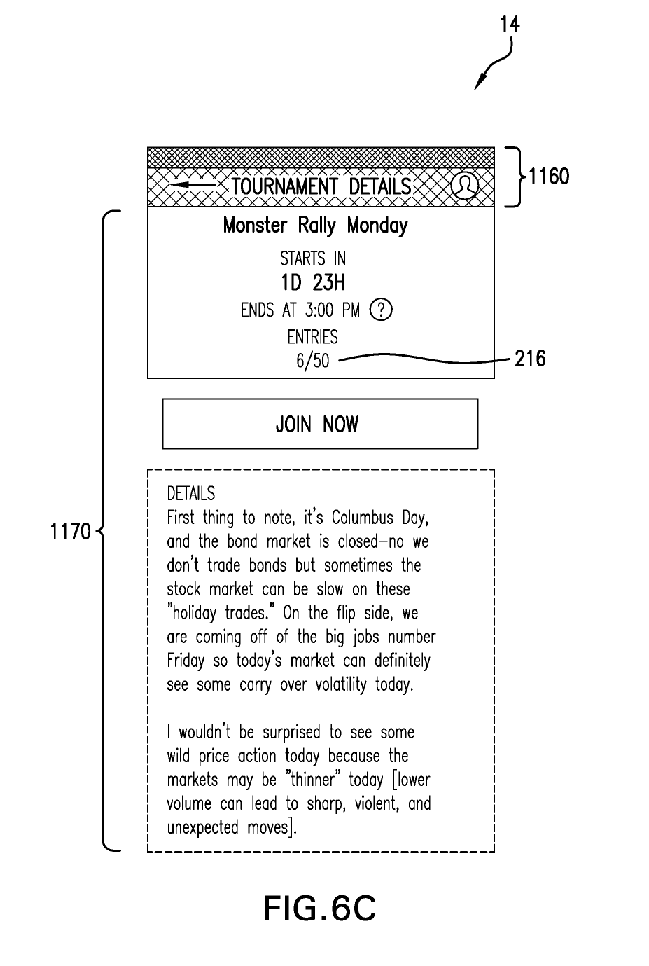

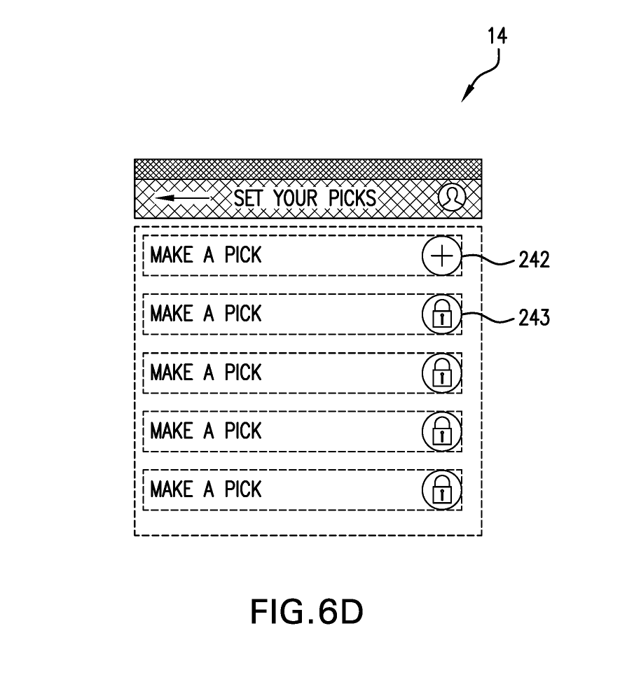

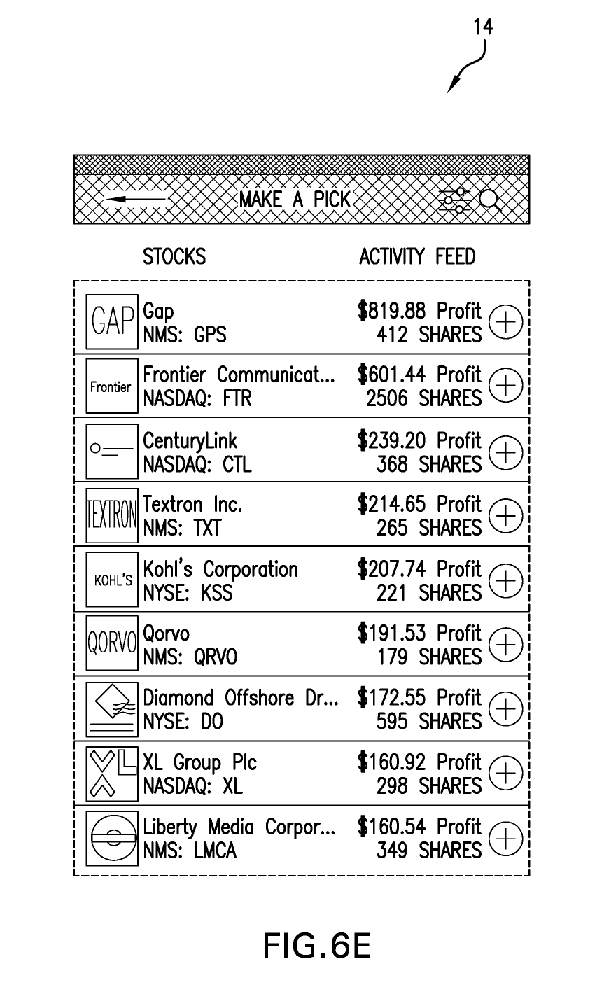

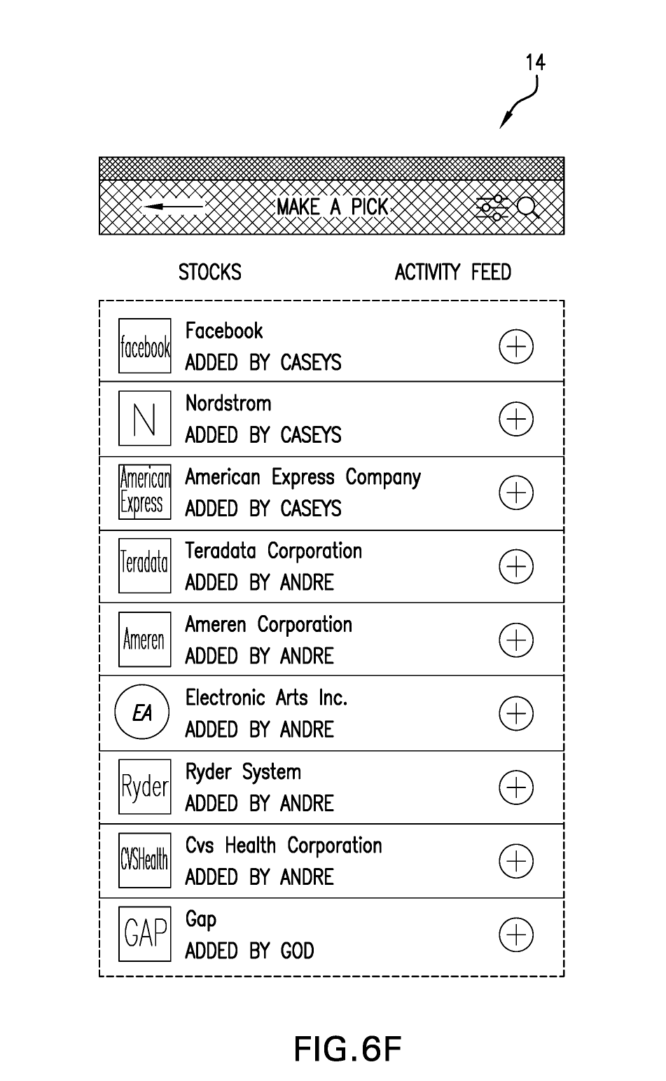

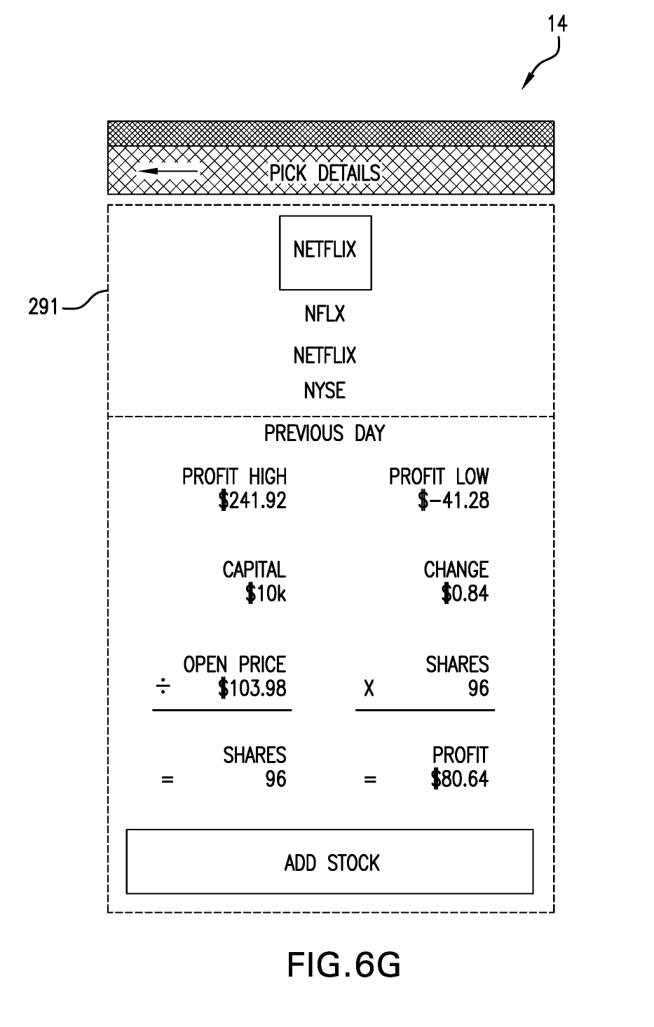

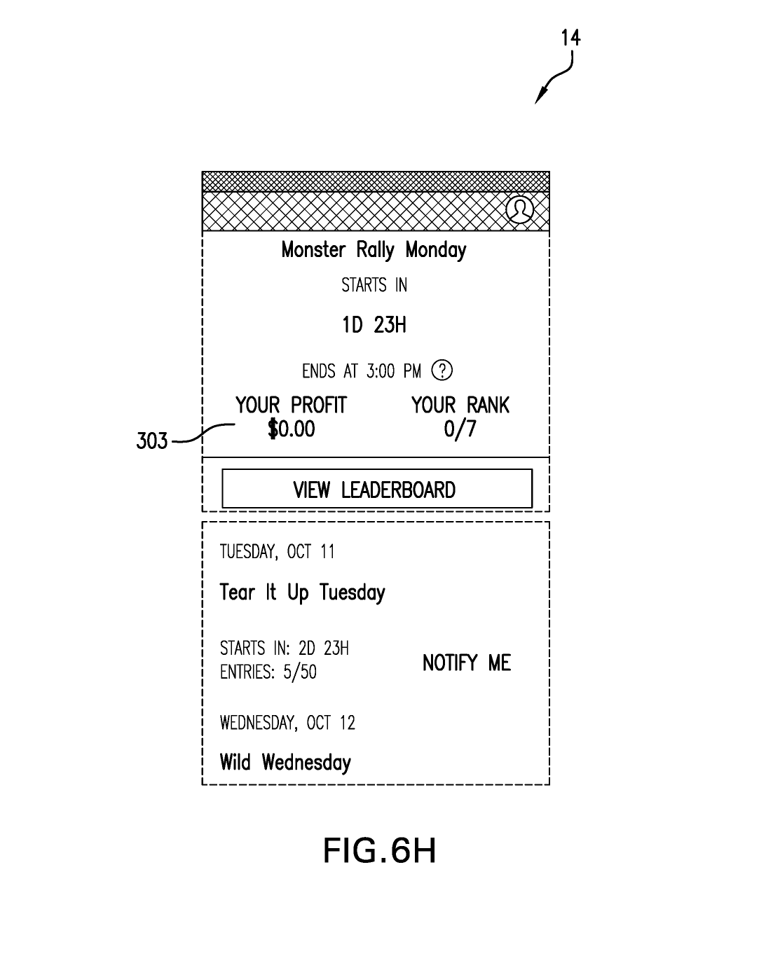

FIGS. 6A-6G provide example graphical user interfaces for the application 12 that may be rendered on the display 14 of the client device 10. Individual graphical components rendered on the display 14 may be generated and provided for display by client device 10, central system 20, or combination thereof. For example, the graphical user interface illustrated in FIG. 6A may include multiple, visually distinctive portions such as a top section 1160 and a bottom section 1170. The top section 1160 may be static while the bottom section 1170 changes dynamically in response to user actions and/or in response to instructions from application 12. The top section 1160 may include an account icon 161 from which the user may access his account.

Various graphical user interfaces may be rendered on display 14 as provided by instructions included in client device application 12 and executed by the client device 10. Alternatively or additionally graphical components may be received and rendered by client device 10 pursuant to instructions and data originating from central system 20.

### Network

Network 30 communicatively couples central system 20, client device 10, and remote servers 40. The network may be wired or wireless or a combination thereof. Network 30 may include multiple types of network such as cellular telephone networks, personal area networks, local area networks, Bluetooth, low energy Bluetooth, Wi-Max, any networks meeting IEEE 802 standards, or a combination thereof. The network 30 may include the Internet or other public networks. Network 30 may include an intranet or other private network. Individual components of the computing system 100 may be communicatively coupled via network 30.

These system architecture components are intended to provide a general understanding of the structure of various embodiments of computing system 100. FIG. 1 and accompanying description is not intended to serve as a complete description of all possible elements and features of apparatus, systems, and processes disclosed. Contemplated embodiments include structural and logical substitutions without departing from the scope of the disclosure.

### System Operation

A variety of operations associated with the disclosed simulated stock market training and gaming environment are performed by one or more components of computing system 100 above. System operations include creation of the simulated environment, governance of all aspects of user play in the simulated environment, gathering data associated with operation of the simulated environment and user interaction, and evaluation of gathered data. Aspects of operation include, but are not limited to, individual and multi- user play, rewards and incentives. Aspects of operation also may include multi-level training and games, including transitional levels in which user actions in the simulated environment correspond to the execution of real-word trading actions.

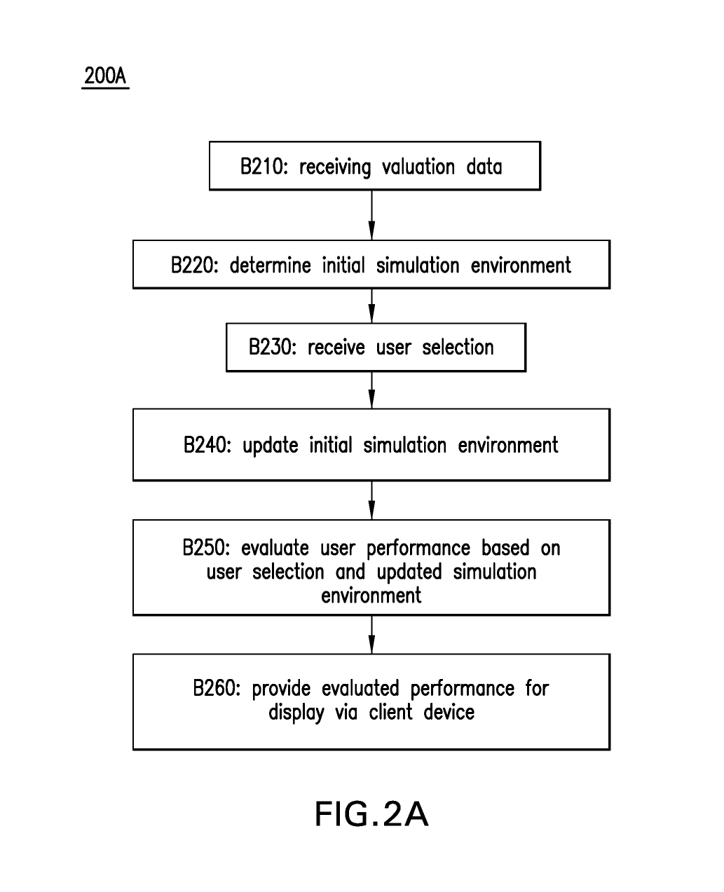

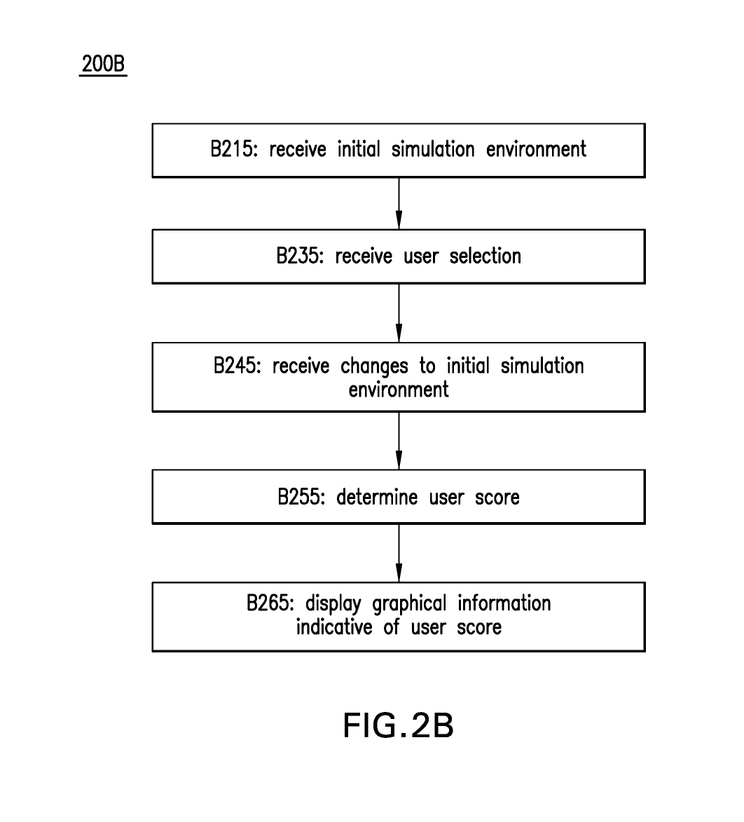

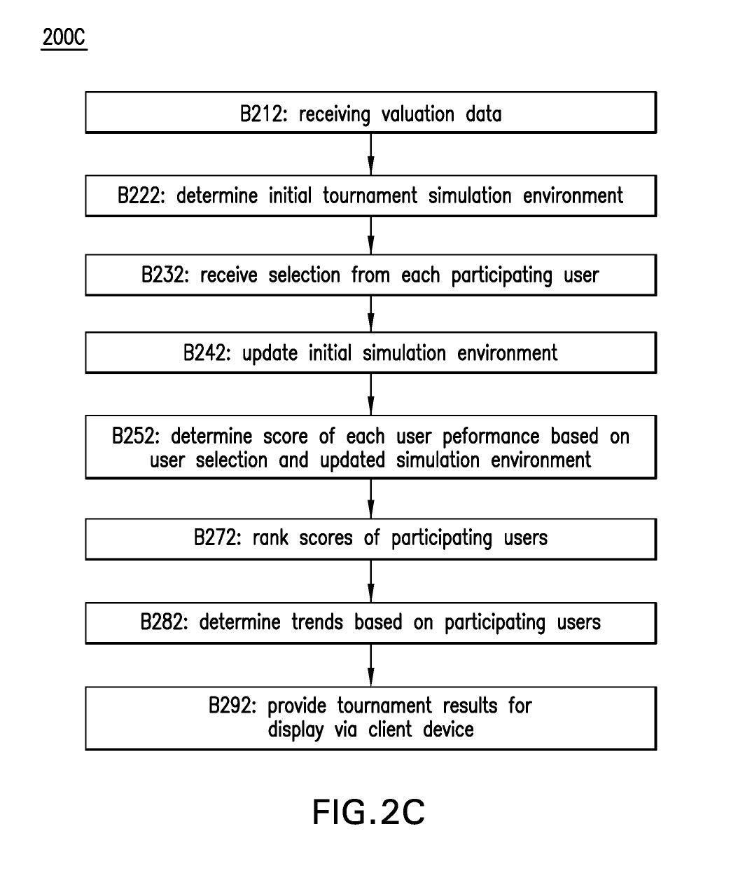

FIGS. 2A-2C and FIGS. 3-4 are flow diagrams illustrating system operation processes in accordance with the simulated training and gaming environment of the present disclosure.

FIG. 2A is a flow diagram in accordance with the simulated training and gaming environment according to the teachings of the present disclosure. FIG. 2A represents an exemplary process 200A that may be performed by central system 20.

In block B210, the server receives valuation data periodically from a remote server.

In block B220, central system 20 determines an initial simulation environment based on received valuation data at a first time.

Central system 20 receives user selections associated with the initial simulation environment in block B230. Central system 20 updates the initial simulation environment based on valuation data associated with a second time.

Central system 20 then evaluates a performance of the user based on the selections of the user, the initial simulation environment, and the updated simulation environment in block B250. In some embodiments, a processor of client device 10 may alternatively execute at least a portion of the evaluation of user performance and subsequently transmit user performance data to central system 20.

Process 200A may optionally send evaluated performance data in the form of graphical representations, infographics, and/or alphanumeric performance evaluation for rendering on display 14 of client device 10, as illustrated in block B260.

FIG. 2B illustrates a process 200B that may be performed by a client device 10.

In block B215, the client device 10 receives a simulation environment, from central system 20. The simulation environment includes a selection of virtual stocks, each having a virtual value based on factual valuation data associated with a first time.

In block B235, the client device 10 receives user selections of at least one virtual stock associated with the simulation environment.

In block B245, client device 10 receives changes to virtual values of the selection of virtual stocks based on factual valuation data associated with a second time.

The client device 10 determines a score of the user based on at least one user selected virtual stock and any received changes to the virtual value of the user selected virtual stock at the second time in block B255.

Client device 10 renders graphical information for display based on the score of the user in block B265.

FIG. 2C describes a process 200C that may be performed by central system 20 facilitating multiple user play. The central system 20 may perform blocks B212, B222, and B242 in a manner similar to the description of blocks B210, B220, and B240, respectively, as previously described with respect to FIG. 2A.

In multiple user play, user selection data is received by central server 20 by each participating user as illustrated in block B232. User selection data may originate from multiple, different client devices 10 via network 30. For example, each user may be participating a single tournament, despite being located in different geographic locations. Each user in a tournament may submit user selection data at any time after registration time begins and prior to the commencement of the tournament.

In block B252, the central system 20 determines a score of each participating user based on determined changes to the simulation environment.

In block B272, central system 20 ranks the performance of each of the users in the tournament.

Process 200C (or other processes) may optionally include determining a trend based on one or more of the user selections of the participants pursuant to block B282. In block B292, a graphical display associated with the determined trend may be provided by central system 20 for display on at least one client device 10. In alternative embodiments, portions of the graphical display may be rendered via individual client devices 10 pursuant to instructions locally stored in the client application 12.

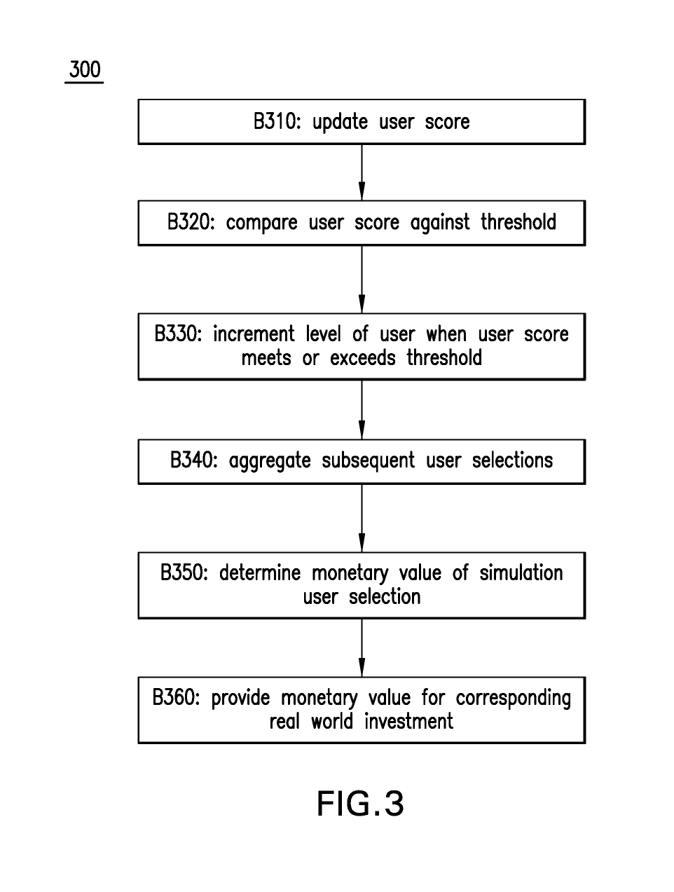

FIG. 3 illustrates an example process 300 that may be performed by central system 20. In some embodiments, portions of process 300 may occur as a part of process 200A of FIG. 2A.

In block B310, the central system updates a user score based on the evaluated performance of the user. In block B320, the central system 20 compares the user score against a next level threshold. In block B330, the central system 20 elevates the level of the user when the user score meets or exceeds the next level threshold. Alternatively, or additionally, the level of the user may be changed based on user inputted selections associated with a change in subscription level of the user.

In block B340 user selections associated with the simulation environment may be aggregated by central system 20 when the user has been elevated to the highest level available to the user.

In block B350, the central system 20 determines a real monetary value associated with the user selections associated with the simulation environment. In block B360, the central system 20 provides an indication of the determined real monetary value for use in a real world investment vehicle.

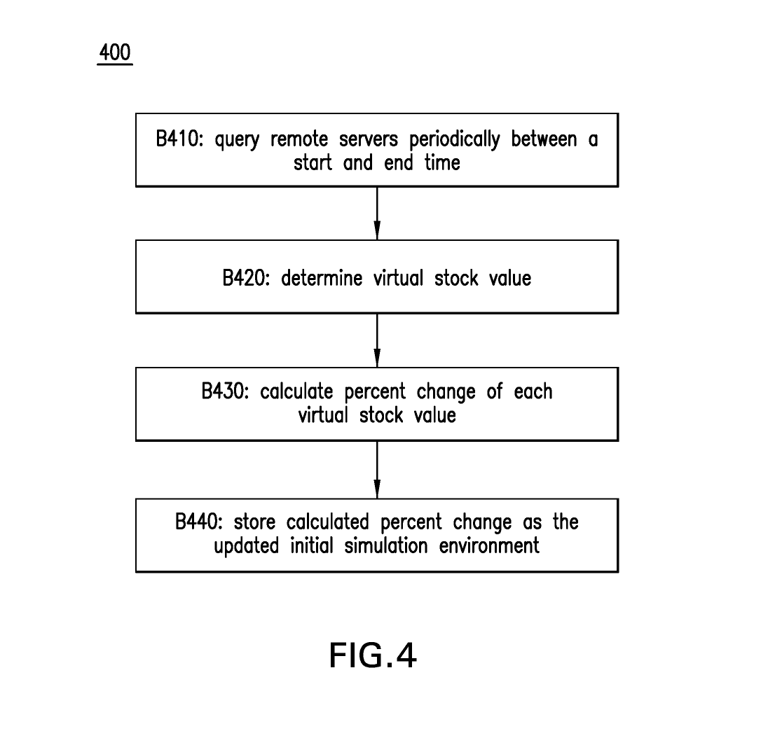

FIG. 4 illustrates an example process 400 that may be performed by central system 20 in order to interpret raw stock data from one or more remote servers 40 in order to create a dynamic simulated stock market environment.

In block B410, the central system 20 queries stock databases for current valuation data associated with virtual stocks of the initial simulation environment during each period occurring between a first time and a second time.

In block B420, the central system 20 determines virtual stock value based on current valuation data. In block B430, the central system 20 calculates the percent change of each virtual stock value based on current valuation data during subsequent periods. The central system 20 then stores calculated percent change and updates the initial simulation environment associated with each virtual stock in block B440.

Processes described in terms of a simulated training environment are equally applicable for simulated game play in a similar manner as described throughout this description.

### Creation of Simulated Environment

The simulated environment includes a virtual stock market, individual and/or multiple user activities, and user accounts associated with each user. The virtual environment may be a training environment for employees in a commercial setting or for users interested in gaining investment skills. Alternatively, or additionally, the simulated environment may be provided in a gaming context. Except where explicitly noted herein, all features and embodiments illustrated in a training environment may also be used in part or whole in a gaming context and vice versa.

Users perform individual and/or multiple user activities (generally referred to in part or whole as “user selections” “stock picks,” “play,” “games,” “training sessions,” and/or “tournaments”). User activities allow user interaction with the virtual stock market of the simulated environment. User activities and/or the simulated environment may be limited. Constraints may be implemented in the structure of the simulated environment. For example, central system 20 and/or client device 10 may include processes or software instruction sets, algorithms, sub-routines and/or computer programs that are indicative of game rules. For example, a multi-level simulated environment may permit access only to users who meet a minimum threshold associated with user success and/or subscription status.

The structure of the simulated environment may encourage individual play or multiple user play. Simulated environments may be structured to include training sessions, games, and tournaments. Simulated environments may also include measures of individual user performance against changing values of virtual stocks in a defined period of time. In other simulated environments, users may be ranked in skill or outcome amongst the users in an identical simulated environment. In some embodiments, users may be permitted to communicate, interact, and/or compete with other users.

The simulated environment may include a virtual stock market. The virtual stock market includes a set of virtual stocks, with virtual stocks representing individual stocks and funds existing in real world exchanges. The number of stocks in the simulated environment may represent only a subset of stocks available in the real world. The name, identifying characteristics, and values of each virtual stock may be identical to real time actual values. Alternatively, a virtual stock may only share some characteristics to its real world counterpart. For example, values of a real world stock may change in real time during the trading day. However, the current value of stock's virtual counterpart may be updated substantially in real time or may be updated regularly and periodically during the same trading day at minute, hour, or other less frequent increments. The central system 20 may obtain stock data in an automated manner by instantiating an API call periodically. For example, the central system 20 may automatically request information every minute, hour, day, or other time period from remote servers storing raw stock data.

The set of virtual stocks may be a predetermined selection of virtual stocks. Administrators and managers of the simulated environment may determine the selection of virtual stocks. In other embodiments, the central system 20 may periodically use raw stock data from remote servers 40 and/or stock information available from other sources to automate the selection of virtual stocks and/or create a dynamic selection that may change automatically over time. Beneficially, automated selection of the set of virtual stocks for the simulation environment reduces the administrative needs of the system. The selection of virtual stocks may be automated by central system 20 based on characteristics of corresponding actual stocks by criteria such as name recognition, volatility, activity, age, or other characteristic or performance metric. Automation may be structured in part or whole as a filtering process, ranking algorithm, query, or other operation.

Central system 20 may obtain data associated with real world stocks by querying raw stock data available from one or more Internet or other sources, such as remote servers 40. Determining each current, virtual value of a single virtual stock may include computational evaluation of raw stock data available from multiple sources. For example, central system 20 may employ an averaging function, a function to determine a median value, and/or filtering functions to determine a current virtual value when multiple sources are available. In some embodiments, the central system 20 may automate the query remote servers 40 based additional or more selective criteria to promote even efficient data processing.

Periodically received, raw stock data may be further evaluated by the central system 20 to determine trends, rates of change, amount of change, or other trend data that is not explicitly provided in the raw data. For example, multiple raw stock values, collected at known points in time, may be used to determine a percent change of value so that the virtual stock has statistical change data in addition to a current value. The central system 20 may determine and store calculated change information expressed as a percentage, ratio, or other format in one or more pricing database associated with the central system. In one example algorithm, incremental changes are determined by subtracting newly acquired Internet stock data value from the most current corresponding value that is stored in the pricing database of the central system 20. Other algorithms may be used to determine average change over multiple periods of time (e.g., such as once an hour per day), over the duration of a tournament, or any other specified period of time. The central system 20 may use algorithms to determine other statistical values for virtual stocks, such as net gains or losses over any period of time.

To promote computational efficiency, statistical operations may be selectively performed by the central system 20 to evaluate currently selected virtual stocks, only virtual stocks associated with a specific tournaments, only those stocks selected by a subset of users (e.g., statistics determined separately based on users in a specific level), and/or specific virtual stocks used in individual play. For computational efficiency, evaluation of raw stock data may be performed only for stocks that have been selected in current instances of the game. That is, if some virtual stocks are available for selection in the virtual stock market, not selected by any user, evaluation of raw stock data may be selectively received and evaluated only for those virtual stocks that are in active use in the gaming environment.

The evaluation of stock data performed by the central system 20 may include the determination of previous day's close value, previous day high value, previous day low values, and the like. This evaluated stock data may be stored in the pricing database and/or in other databases of the central system 20. Data in the pricing database and other databases of the central system 20 may further include statistical results following analytics on the existing data performed by the central system.

### User Performance Data

The central system 20 may also receive and store and evaluate user account data and historical user performance. The central system may include one or more dedicated databases to store these types of user performance data. Additionally, databases of the central system may store historical information associated with tournament events, group performance data, individual user performance data, stock selection of each user in a tournament, and the like. Individual user information may include the time at which picks are made, popularity of those picks amongst groups of users, and other data indicative of popularity of tournaments or tournament features. User performance data and game data may be stored in an event log.

Historic user performance stored in one or more central systems databases may be used to analyze user's actions, user habits, and/or the performance of the user over time. User account preferences may be considered in the evaluation (e.g., which games are preferred, user frequencies, a user's geographic location while interacting with client application 14 and the like).

Other categories of data associated with user performance may include user account data, user stock picks, times at which stock selections are made, frequency of each stock pick, popularity a stock pick for the purposes of creating statistics and probabilities associated with individual user play. For the purpose of determining user trends, individual user selections for one day may be considered analogous to the selection of one user in a single tournament. Additionally, user activity trends such as which tournaments a user chooses to participate in and which tournaments the user chooses not to participate in and other habits and the gaming environment may be collected and stored. This user data may be stored and analyzed to determine characteristics statistics for users, groups of users, tournaments and the like. Stored data may be organized by user, tournament, virtual stock, and/or other criteria.

Data from the pricing databases and historic performance data may be further used to analyze stock trends and user actions. Data may be collected by the central system 20 to establish training data sets for machine learning applications.

### Individual User Play

In each instance of individual user play, the user makes a predetermined number of virtual stock picks using virtual funds in an account of the user. Each user selection (also referred to herein as “stock pick” and “user stock pick”) constitutes the selection of a single virtual stock from a set of available virtual stocks in the simulation environment. In some embodiments, the user may select only one stock. In other embodiments, an individual user may select multiple stocks. In multilevel play based on cost, a free level of play may allow a user to pick only one stock per tournament. A higher level of play, such as a paid version may include a monthly subscription fee, may permit the user to pick multiple stocks per tournament. The stock picks of a single user in each instance of individual user play and tournament may constitute a fantasy stock portfolio.

Each virtual stock pick corresponds to a fixed price per pick that is debited from the virtual funds in a user account (e.g., 10,000 virtual dollars per stock pick). The number of shares acquired in the simulated environment is further determined by the virtual value of the virtual stock. Stock picks are thus translated into a number of shares that are virtually purchased or selected by the user. Central system 20 determines virtual values for the initial simulation environment based on a beginning time of individual or tournament play (e.g., initial simulation environment valuation is based actual stock values prior to the day's opening bell, the start of the virtual trading event, or at another designated first time associated with a single instance of individual play or for each tournament). The price per pick may be an automatically determined value based on the level of the user, the current balance in a user account. The virtual balance in the account of the user may be a pre-determined value at the commencement of each instance of individual play (and also for each user at the beginning of each tournament).

Within each game in the virtual environment, the user may have a fixed virtual budget with which to pick virtual stocks for each game, day, or tournament. The fixed budget for each game, day or tournament is not limited by total earnings values. Advantageously, beginning users are not prevented from fully participating in subsequent games, even if the user's previous games have resulted in only losses. Accordingly, users are provided with a renewed opportunity to try again and learn in each game.

FIGS. 6D, 6E, 6F, and 6G depict example graphical user interfaces for display 14 of client device 10 for user selection at the beginning of individual play or tournament registration. The predetermined number of selections may be graphically indicated as in items 242 and 243 of FIG. 6D. As depicted in FIG. 6E and 6F, a listing may be provided for display including information associated with each virtual stock including, but not limited to: a stock name, a profit indicator (e.g., the total profit all tournament users of the computing system 100 have made by selecting the stock), a number of shares (e.g., the total number of shares all users of the computing system 100 have picked), and an interactive icon through which the user may make a selection. Stock information may be sorted for display in descending order of profit with the highest profit stock listed first. As illustrated in 6F, associated stock information may provide an activity feed ordering the virtual stock listing based on most recent selection and/or identifying a user who has selected the virtual stock. FIG. 6G depicts a graphical user interface that may be rendered on display 14 of client device 10 representing a single virtual stock. The graphical display may provide statistical or other types of information associated with the stock including, but not limited to: a company information section 291 (e.g., information about the company for which the stock represents, including the name of the company, the logo of the company, and the exchange for which the stock belongs (e.g., NYSE, Nasdaq)), and a stock financial section (e.g., financial information of the stock from the previous day's trading, including the highest and lowest profit the stock returned, the opening stock price, the number of shares purchased by users the previous day, and the total profits received by all users the previous day).

The user may then track the performance of his stock picks over the course of the trading day. The performance of the user may be determined at the end time of individual or tournament play (e.g., after market close, the end of the virtual trading event or at another designated second time associated with a single instance of individual play or for each tournament). The performance of the user may also be determined in an ongoing fashion based on the performance of the user in tournaments and/or daily play over time.

Each game is based on the value of the virtual stock at the end of the duration of the game. The duration of individual games may be a single day, week, quarter or any other period of time. The duration of the individual game may be set by an administrator or may, in some embodiments, be selected by user settings. One preferred duration may commence just prior to the open of the trading day and terminate following after the end of the trading day. Accordingly, the initial and final values of virtual stock values correspond to the opening values and closing values of the actual stock market.

Virtual stock value at the end of a game determines performance of the user during the game. For example, the value of the selected virtual stocks at the end of the day is determined based on the closing price of the corresponding, actual stock on the day the game is played. If the virtual stock price exhibits a net increase from the beginning to the end of the game, the performance of the user may be a single value 232a (e.g., based on the virtual dollar value equivalent to the stock price increase multiplied by the number of shares purchased by the user). Accordingly, profit values may be credited in virtual funds to the running total data associated with the user. If the virtual stock price exhibits a net decrease, the performance of the user may be a loss value equivalent to the magnitude of the stock price decrease multiplied by the number of shares purchased by the user. If the user loses money, the system may subtract the loss value from the running total associated with the user.

### Multiple User Play

In multiple user play, each user competes in a group of other users in an activity (also referred to as “tournament” herein). Each tournament includes a start time, an end time, and an enrollment period, and a total number of permitted participants for the tournament.

In some embodiments, the simulation environment may limit participation of each user to individual user play one or more tournaments simultaneously. Participation limitations may be based on the level of the user. A user may be limited to the number of tournaments that may be undertaken based on an overlap in time.

The user may simultaneously engage in individual user play as well as multiple tournaments. Each instance of individual user play and each tournament may operate independent of selections and values in other events occurring at the same time. For example, the user may conduct daily individual play while participating in multiple tournaments on the same day (e.g., for each game, the selection of virtual stocks, initial available account balances and all other game and user details may not affect the other user's games) In other embodiments, aspects and user actions in individual games and tournament actions may affect aspects of another game. For example, a user may have the maximum number of virtual stock picks at any one time or a single virtual investment total that the user must distribute amongst the tournaments and individual games in which the user is participating.

The winner of a multi-user game may be the user having the virtual stock portfolio with the highest gains at the end of the tournament. Tournament winners may receive an incentive or reward, such as a monetary bonus (real or virtual) deposited into an account of the user. Rewards may be used in the game context or investment context to pick additional stocks.

FIG. 6B illustrates an example tournament lobby graphical user interface for display 14 of the client device 10. Lists of active tournaments and/or future tournaments may be provided for display. An active tournament is a tournament that has not yet started, but one in which the user is eligible to participate. A tournament may be active for any pre-set period of time, such as one day, one week, or one month. A user may reserve a spot in a tournament before making stock selections for the tournament. Types of information associated with active tournament listing 210a are also depicted in FIG. 6B (and also FIG. 6C). Active tournament information may include: the start date of the tournament, the name of the tournament, countdown time until the tournament starts, the current number of entries in the tournament, and the total number of entries allowed in the tournament as illustrated in the graphical user interface of FIG. 6B. As illustrated by ratio 216 of FIG. 6B, a tournament may allow 50 participants, and 6 users have already entered, displayed “6/50”.

A future tournament is a tournament that has not yet started, but one the user cannot yet join. FIG. 6B further illustrates future tournament listing 220a that may also be listed with tournament identifying details. Future tournament listing may include a notification button 221. When selected by the user, client device application 14 may display or transmit a notification indicating that the future tournament is now active, notifying the user that registration for the tournament is now permitted.

FIG. 6H illustrates an example tournament graphical user interface for display 14 of the client device 10 while participating in an ongoing tournament. A listing of ongoing and future tournaments in which the user is registered. Types of information displayed in an ongoing tournament may include tournament-identifying details that may include current rank, score, profits, or other current user performance metrics of the participating user. Users may be ranked against one another based on profits earned by the fantasy stock portfolio, with the highest profit having the highest ranking. For example, in FIG. 6H, the statistic 303 displays the profits of the user calculated based on the total gains of the virtual stocks selected by the user in that particular tournament.

Each user selects a fantasy stock portfolio prior to the beginning of the tournament. The number of users in each tournament may be predetermined by the game administrator. The performance of each fantasy stock portfolio of each user is compared to other users in the group. The value of the stock portfolio is governed by the performance of those virtual stocks over the duration of the tournament. No real world trading may occur through the game based on tournament play. In some embodiments, tournaments may allow users to buy and sell stocks with other users during the tournament. In other embodiments, no stock trades are permitted between users. At the end of the tournament, the performance of the stocks is tracked. The performances at the virtual stock portfolio are determined based on the determined length of time of the tournament. Realism and market volatility are provided in the virtual environment by determining the value of each virtual stock based on the performance characteristics of the actual stock market performance of actual stocks corresponding to stocks in the virtual environment.

Users may be restricted from changing stock picks once a tournament has commenced. In alternative embodiments, the user may have a limited number or unlimited opportunities to change her stock picks during the duration of the tournament. Penalties or charges may be applied based on virtual charges affects the user's ultimate performance in the tournament.

Tournament play may be calculated and analyzed separate from the user's individual play such that the user's ongoing earnings score is not affected by any tournament play. A tournament may be structured such that users may participate in tournaments only against other players at the same player level. Alternatively, tournaments may separately score the performance of users against only other users in at the same individual skill level. Alternatively, users may be scored regardless of their level. Administrators of the gaming environment may have access to the virtual stock selections of users at one or more levels.

### Multiple Level Training and Gaming

Establishing hierarchical levels of play may incentivize user participation. Levels in a hierarchical structure may be based on the degree of user skill and/or cost. Levels of the hierarchy may be characterized by one or more ranges, rankings, or may be established based on one or more thresholds. Limitations and features of the simulated environment may also vary based on level. Advancing between the levels may be determined by the user's account balance (e.g., running total) meeting or exceeding a threshold.

In a skill-based level hierarchy, users may progress from one level to another level based on average performance, cumulative performance, and/or multiple thresholds such as total value of earnings within a most recent period. Higher levels in a user performance based level structure may indicate increasing skill, competence, high frequency of user participation, or longer history of user participation. One measure of the user performance may be determined based on a “running total” (e.g., virtual income statement) associated with each user account. The running total may track profits and losses based on the change in value of all historical stock picks of the user and may be tallied as gains and losses for each user daily trading session. Thresholds for each level based on running total may be expressed as a dollar value. Advancement between levels may be determined in more complex ways such as a threshold based on total number of earnings within a specific specified duration of time; that is, a sustained or increasing rate of earning over time rather than solely the value of total earnings. A running total may be “reset” by user request to mitigate any long-term effect of sustained losses. A reset may require a monetary fee paid by the user. One embodiment of the reset process is illustrated in FIG. 13. Other limits on resets may be placed, such as, limiting the total number of resets for a user account, or limiting the total number of resets in a duration of time for a user account.

In a cost-based hierarchical structure, limited versions of the game may be associated with lower levels of the hierarchical. The lowest level in the hierarchy may be a free version of client device application 12 that is available to any user without any initial cost or subsequent subscription fees. Upper levels in the cost-based hierarchy may include additional game features, additional complexity, user customizations, and more generous rewards. The highest level in a cost-based structure may have the most expensive one time download cost and/or recurring subscription fee. A lowest level may be a free level of the game that limits the number of stock picks for each user (e.g., at a free level of play, the user may be limited to a single virtual stock pick for each day of individual play and/or a single selection for each tournament, as illustrated in FIG. 6D). A free level of gameplay may further limit the amount of virtual money a user may use during each day of play. In another example, a highest level in a cost-based structure may be a “pro” level requiring a monthly subscription fee. The pro level may also provide larger amounts of virtual money for each daily investment and tournament, and may allow the user to select multiple stock picks in each day of individual play and/or in each tournament.

In some embodiments, thresholds and rewards may be determined by user selection. For example, a user may be permitted to associate personal goals or objectives as thresholds. The user may be permitted to determine all threshold values in some multiple level hierarchies. Some individual levels or some multiple level hierarchical structures may permit the user to select from a predetermined range to customize the simulated environment. Rewards may increase in perceived or actual value at higher levels. Lower level rewards may include reduction in ad display, customizations of the client device 10 (such as bonus colors or themes that may be applied to the graphical user interface), or other rewards benefiting user experience. Higher levels of rewards may include virtual cash bonuses applied to the running total. Some rewards may be available only at the highest level of the hierarchy. For example, a subscribing user that has achieved the highest level of the hierarchy may be eligible to receive discounts on subscription costs, real monetary rewards or gift cards that are proportional to the users performance. A value of the reward may be proportional to the value of daily profits as measured by a user's gains during one day of individual play. Some rewards may correlate to a percentage related to virtual dollar value of gains in a running total for the user. For example, one real dollar cash rewards may be awarded to the user for every virtual one hundred or one thousand dollar gain in the running total of the user. Other rewards available to users in selected high levels advance the complexity of the simulated trading environment by incorporating live trading in tandem or transitioning from the virtual environment to a real trading environment.

Transition from Virtual Environment to Real Trading Environment

In some embodiments, the simulated environment may be coupled with an actual brokerage account. This feature of the simulated environment may be accessed only at high levels of play based on user skill hierarchies and/or cost based hierarchies. This feature may be used as a reward option available to users meeting or exceeding a threshold of total earning value (e.g., a “pro” level user account). In order to enter the “pro” level, the system may require the user to grow her virtual income statement to a predetermined threshold value (e.g., $2,500). The user may then fund a real brokerage account via the user's bank account or credit card associated with the user's account. Once a user has achieved “pro” level, the user's account (e.g., running total, “pro” wallet) may be reset to zero. The value of the running total of the user may then deposit real funds associated with the account of the user. Additionally, or alternatively, the environment may provide one or more preset values to the user's “pro” level account without requiring the user to deposit matching, real funds to the account of the user. For example, a “pro” level user account may be gifted a pre-set starting balance, or the environment may provide offers or rewards increasing the value of the user's “pro” level account. The simulated environment may further allow a user to play in lower level play even after advancing to a higher level. For example, the simulated environment may allow a “pro” level user to play in a lower level for the purpose of “resetting” the user's pro level account. That is, the user may play in a lower level and re-qualify for pro level play by growing the user's virtual income statement to the predetermined threshold value. Once the threshold is achieved, the user's existing pro level account is cleared or “reset.”

Once the user exceeds the threshold and achieves a “pro” level account, the user may then make virtual stock selections within the game that also correspond to one or more real world investment vehicles. For example, a user eligible to receive this type of reward makes stock selections in the virtual environment. The selections of the user are evaluated and aggregated by the central system and sent to another party to execute actual trades in the existing stock market. The central system 20 may work in tandem with other third parties to instantiate user's picks within a simulated environment in a real trading vehicle. That is, the selections of the user in the virtual environment are sent to the central system 20 from the client device 10. Then, the central system 20 communicates corresponding stock purchase requests for execution in the real world market. The user may be required to select stock picks by a certain time (e.g., prior to opening of the corresponding real world market, or anytime following the close of the previous day's trading and prior to the opening of the corresponding real world market), in order to determine the time of the execution of the real world trade (e.g., selected stock picks prior to opening of a real world market are executed at actual opening time of the real world market on the same day). Individual brokerage accounts may be set up for each user, or the central system 20 may set up and/or actively manage funds based on the user selections. Selections in the virtual stock market environment may be executed in the real stock market with a direct correlation between actual purchase values, or real world portions may be purchased as a percent of the virtual purchase to manage the quantity of financial risk. In some embodiments, selection of a stock pick in the simulation environment is entered by the user. The system automatically sends information of the stock pick of the user to an administrator, manager, or technician associated with the system. The user's stock selection may be sent to databases associated with the central system and/or may be sent as a communication (e.g., an email, text message, SMS message) directed to the administrator, manager, or technician. In one embodiment, the user's stock picks are purchased on the actual stock market with a Market On Open (MOO) order and sold with a Market On Close (MOC) order through interactive brokers. The purchase and sale of the actual stock may be conducted over a single, actual trading day or may correspond to longer durations of time corresponding to the duration of individual play or the duration of a tournament. In some embodiments, the entire process of executing received stock pick information of the user may be fully automated and executed by the system without any human intermediary. In some embodiments, the user has no direct access to the real world trading account implementing corresponding real world stock picks, regardless of whether trading conducted with the aid of an administrator of the system or fully automated by the system.

If gains are made following this type of “pro” play, the user may then withdraw real money from her account and transfer it into a personal bank account. When the user withdraws money from her account, the user may receive the total gains available for withdrawal. Alternatively, the user may receive a profit split of the total gains available for withdrawal. The profit split may be based on a percentage of total gains, for example, the user may receive a profit split of 80% of the total gains available for withdrawal, while the system keeps 20% of the total as a subscription fee or other fee. In some embodiments, withdrawals (including those based on profits) are taken from the user's “pro” level running total at the time of the withdrawal request. Requests for withdrawals may include requests to withdraw earned gains, withdrawal of the entire “pro” level user wallet, or the like. Some or all types of withdrawals may be split, such that the system may deduct a value or percentage of the requested withdrawal for the purpose of charging fees to the user.

The performance of the user during individual play may be associated with the profile of the user. The user account may include a running total of virtual earnings as a measure of success and improvement, updated with the user's daily performance. This virtual running total may not affect the virtual budget a user has for each game, as each user may be presented with a predetermined amount of virtual cash to invest at the start of each game. The predetermined budget may be static or may increase as a level of the user is advanced. Alternatively, or additionally, the budget for each user may be dynamically based on his user performance.

Losses in “pro” level play may be limited. That is, a predetermined maximum loss limit may be applied to each user account at the “pro” level. Accordingly, once the maximum loss limit in a “pro” account is reached, the simulation environment may automatically cause corresponding real world investments to be liquidated in order to mitigate losses. In some embodiments, the user's account may be demoted to a lower level of play in the multi-level hierarchy once the maximum loss limit has been reached. The user must then re-qualify for each lost level in the hierarchy.

### Creation of User Account

User data may be associated with an account of the user and may include information input by the user during a registration process. A user account may be associated with both historical user information and user provided information.

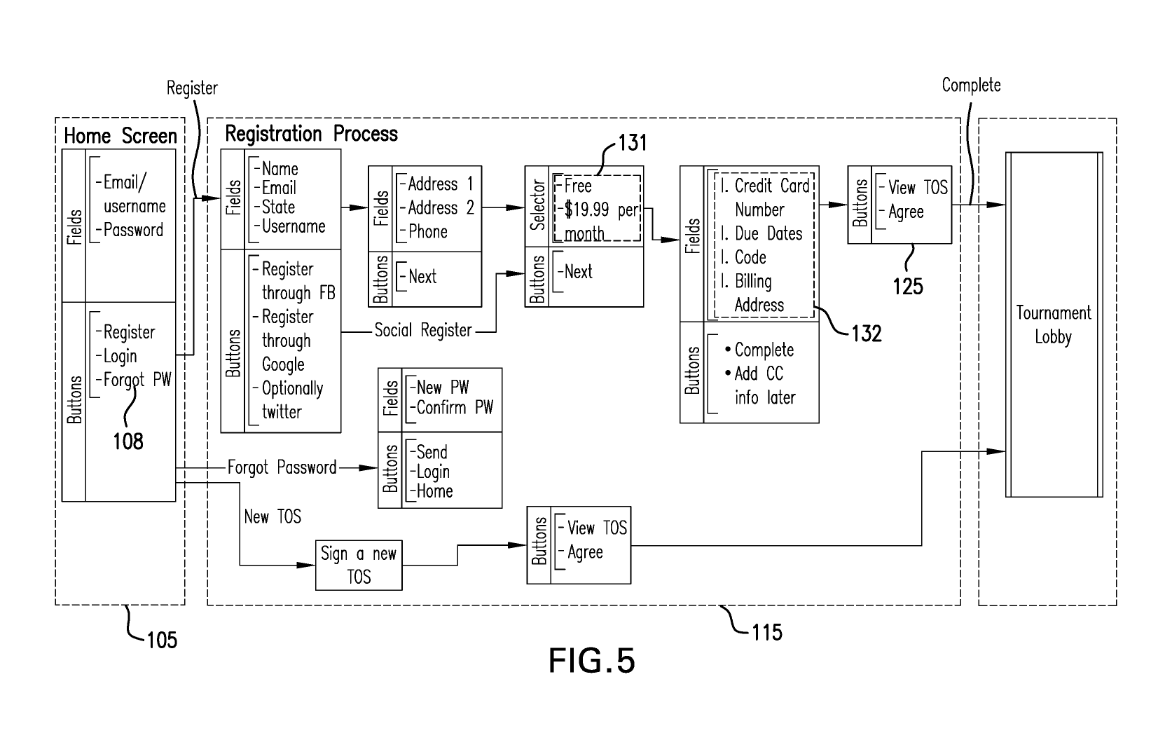

FIG. 5 is an exemplary wireframe template for a client device application 12 of the system illustrated in FIG. 1. Via client device 10, the user may initially register for a user account via one of two registration processes 115. The user may register by creating a user account by entering his name, email address, home state, and user name by manually inputting user information into the input fields of a graphical user interface. Alternatively, user account information for a pre-existing social media account (e.g., Facebook, Google, and, Twitter) may be accessed and automated by the client application 12. Client application 12 and client device 10 may execute instructions to access pre-existing social media account information from a remote server 40 communicatively connected via network 30 upon receipt of login credentials from the user.

Graphical user interfaces associated with the registration or login process may be accessed via the display 14 of the client device 10, and may, include home, registration and tournament lobby graphical user interfaces. Users with a pre-existing account may input his username (e.g., the user's email address) and password to login into his account from the home graphical user interface 105.

Illustrations are merely representational and are not drawn to scale. Accordingly, the disclosure and accompanying figures are illustrative rather than restrictive. Specifics provided herein are not intended to be construed as limitations on the scope of the invention or of what may be claimed but are instead descriptions of features specific to particular embodiments of the invention. Features described in the context of separate embodiments may be implemented in combination in a single embodiment.

Operations, processes, blocks, and acts are illustrated in the drawings and described in a particular order. However, no particular order should be construed as a requirement that operations must be performed exclusively within the sequential order. Additional or fewer operations may be performed or operations may be advantageously performed using parallel processing.

It is intended that the foregoing detailed description be regarded as illustrative rather than limiting and that it is understood that the following claims including all equivalents are intended to define the scope of the invention.

What is claimed is:

1. A system for generating a virtual stock market environment that mirrors an actual stock market in real-time that corresponds to a user selection and provides real-time feedback to an engagement of a user in the virtual stock market environment, comprising:
at least one processor; and
a memory coupled with the processor, the memory including instructions that, when executed by the processor cause the processor to:
receive the user selection that corresponds to an actual stock pick that is available in the actual stock market that the user requests to enter into the virtual stock market environment,
assess a virtual stock value for the user selection that incorporates a real-time assessment of an actual value of the actual stock pick that corresponds to the user selection as determined from the actual stock market,
engage the user selection into the virtual stock market environment to expose the user selection to a fluctuation of the virtual stock market environment that mirrors the actual stock market in real-time,
incorporate raw stock market data aggregated from the actual stock market in real-time into the virtual stock market environment, wherein the raw stock market data is an actual representation of the actual value of the actual stock pick in the actual stock market in real-time, and
determine the virtual stock value of the user selection in real-time in the virtual stock market environment based on the raw stock market data aggregated from the actual stock market as the raw stock market data fluctuates in real-time relative to the actual stock market fluctuating in real-time.

2. The system of claim 1, wherein the processor is further configured to:
aggregate virtual stock market data associated with the user that provides a virtual performance of the user as the user previously engaged in the virtual stock market environment;
generate a virtual portfolio for the user that incorporates the aggregated virtual stock market data associated with the user that is a real-time assessment of the virtual performance of the user as the user previously engaged in the virtual stock market environment; and
assess a virtual portfolio value for the user that incorporates the real-time assessment of the virtual performance of the user that provides in real-time a valuation of the virtual portfolio relative to the virtual stock market environment.

3. The system of claim 2, wherein the processor is further configured to:
apply the virtual stock value of the user selection as assessed in real-time to the virtual portfolio value of the virtual portfolio of the user as assessed in real-time; and
determine the virtual portfolio value of the virtual portfolio of the user in real-time as the raw stock market data is aggregated into the virtual stock market environment in real-time triggering the virtual stock value to fluctuate in real-time thereby causing the virtual portfolio value to fluctuate in real-time.

4. The system of claim 3, wherein the processor is further configured to:
determine the virtual portfolio value of the virtual portfolio in real-time following a closing period of the virtual stock market environment, wherein the closing period of the virtual stock market environment is when the aggregation of the raw stock market data from the actual stock market into the virtual stock market environment is ceased thereby causing the virtual stock market environment to not fluctuate;
apply the virtual stock value of the user selection as assessed in real-time at an opening of an active period of the virtual stock market environment to the virtual portfolio as determined at a previous closing period of the virtual stock market environment, wherein the opening of the active period of the virtual stock market environment is when the aggregation of the raw stock market data from the actual stock market into the virtual market environment is initiated and is continued following the previous closing period and before a subsequent closing period following the active period; and
determine the virtual portfolio value of the virtual portfolio of the user in real-time as the raw stock market data is aggregated into the virtual stock market environment in real-time triggering the virtual stock value to fluctuate in real-time thereby causing the virtual portfolio value to fluctuate in real-time during the active period.

5. The system of claim 4, wherein the processor is further configured to:
assess the virtual stock value of the user selection in real-time in the virtual stock market environment based on the raw stock market data aggregated from the actual stock market in real-time relative to a plurality of virtual stock values of a plurality of user selections received from a plurality of users engaging in the virtual stock market environment; and
determine a virtual stock value ranking of the user in real-time based on the virtual stock value of the user selection as determined from the raw stock market data aggregated from the actual stock market in real-time relative to the virtual stock values associated with the user the selections received from the users engaging in the virtual stock market environment, wherein the virtual stock value ranking of the user in real-time fluctuates as the raw stock market data aggregated from the actual stock market fluctuates and the virtual stock market values associated with the user selections received from the users fluctuate.

6. The system of claim 5, wherein the processor is further configured to:
assess the virtual portfolio value of the virtual portfolio of the user in real-time in the virtual stock market environment based on the raw stock market data aggregated from the actual stock market in real-time time relative to a plurality of virtual portfolio values of a plurality of virtual portfolios associated with the plurality of users engaging in the virtual stock market environment; and
determine a virtual portfolio value ranking of the user in real-time based on the virtual portfolio value of the user as determined from the raw stock market data aggregated from the actual stock market in real-time relative to the virtual portfolio values associated with the users engaging in the virtual stock market environment, wherein the virtual portfolio value ranking of the user in real-time fluctuates as the raw stock market data aggregated from the actual stock market fluctuates and the virtual portfolio values associated with the users fluctuate.

7. The system of claim 6, wherein the processor is further configured to:
evaluate the virtual portfolio value of the user in real-time to determine a performance record in real-time of the user as the user engages the virtual stock market environment, wherein the performance record of the user depicts a performance of each user selection in the virtual stock market environment as provided by the virtual portfolio value.

8. The system of claim 7, wherein the processor is further configured to:
assess an actual monetary value of the user selection in real-time that corresponds to the actual stock pick into the actual stock market, wherein the actual monetary value is a monetary value of the user selection that the user is to pay to an actual stock market broker to engage the user selection into the actual stock market; and
engage the received user selection that corresponds to the actual stock pick into the actual stock market to simultaneously expose the user selection to a fluctuation in the actual stock market and the fluctuation in the virtual stock market environment that mirrors the actual stock market in real-time, wherein the user pays the actual monetary value to the actual stock market broker to engage the user selection into the actual stock market.

9. The system of claim 8, wherein the processor is further configured to:
evaluate the performance record of the user to determine a performance threshold that the performance record of the user satisfies;
assess the virtual stock value of the user selection in real-time in the virtual stock market environment relative to a plurality of virtual stock values of a plurality of user selections received from a plurality of users that is positioned in the performance threshold of the user;
assess the virtual portfolio value of the virtual portfolio of the user in real-time in the virtual stock market environment relative to a plurality of virtual portfolios associated with the plurality of users that is positioned in the performance threshold of the user; and
determine the virtual stock value ranking and the virtual portfolio value ranking of the user in real-time based relative to the plurality of users that is positioned in the performance threshold of the user.

10. The system of claim 9, wherein the processor is further configured to:
assess the actual monetary value of the user selection in real-time that corresponds to the actual stock pick in the actual stock market when the performance record satisfies an actual stock market participation threshold, wherein the actual stock market participation threshold is a threshold that is indicative that the user is capable of engaging the actual stock market with the user selection; and
engage the received user selection that corresponds to the actual stock pick into the actual stock market to simultaneously expose the user selection to the fluctuation in the actual stock market and the fluctuation in the virtual stock market environment so the user pays the actual monetary value to the actual stock market broker when the performance record of the satisfies the actual stock market participation threshold.

11. A method for generating a virtual stock environment that mirrors an actual stock market in real-time that corresponds to a user selection and provides real-time feedback to an engagement of a user in the virtual stock market environment, comprising:
receiving the user selection that corresponds to an actual stock pick that is available in the actual stock market that the user requests to enter into the virtual stock market environment;
assessing a virtual stock value for the user selection that incorporates a real-time assessment of an actual value of the actual stock pick that corresponds to the user selection as determined from the actual stock market;
engaging the user selection into the virtual stock market environment to expose the user selection to a fluctuation of the virtual stock market environment that mirrors the actual stock market in real-time;
incorporating raw stock market data aggregated from the actual stock market in real-time into the virtual stock market environment, wherein the raw stock market data is an actual representation of the actual value of the actual stock pick in the actual stock market in real-time; and
determining the virtual stock value of the user selection in real-time in the virtual stock market environment based on the raw stock market data aggregated from the actual stock market as the raw stock market fluctuates in real-time relative to the actual stock market fluctuating in real-time.

12. The method of claim 11, further comprising:
aggregating virtual stock market data associated with the user that provides a virtual performance of the user as the user previously engaged in the virtual stock market environment;
generating a virtual portfolio for the user that incorporates the aggregated virtual stock market data associated with the user that is a real-time assessment of the virtual performance of the user as the user previously engaged in the virtual stock market environment; and
assessing a virtual portfolio value for the user that incorporates the real-time assessment of the virtual performance of the user that provides in real-time a valuation of the virtual portfolio relative to the virtual stock market environment.

13. The method of claim 12, further comprising:
applying the virtual stock value of the user selection as assessed in real-time to the virtual portfolio value of the virtual portfolio of the user as assessed in real-time; and
determining the virtual portfolio value of the virtual portfolio of the user in real-time as the raw stock market data is aggregated into the virtual stock market environment in real-time triggering the virtual stock value to fluctuate in real-time thereby causing the virtual portfolio value to fluctuate in real-time.

14. The method of claim 13, further comprising:
determining the virtual portfolio value of the virtual portfolio in real-time following a closing period of the virtual stock market environment, wherein the closing period of the virtual stock market environment is when the aggregation of the raw stock market data from the actual stock market into the virtual stock market environment is ceased thereby causing the virtual stock market environment to not fluctuate;
applying the virtual stock value of the user selection as assessed in real-time at an opening of an active period of the virtual stock market environment to the virtual portfolio as determined at a previous closing period of the virtual stock market environment, wherein the opening of the active period of the virtual stock market environment is when the aggregation of the raw stock market data from the actual stock market into the virtual market environment is initiated and is continued following the previous closing period and before a subsequent closing period following the active period; and
determining the virtual portfolio value of the virtual portfolio of the user in real-time as the raw stock market data is aggregated into the virtual stock market environment in real-time triggering the virtual stock value to fluctuate in real-time thereby causing the virtual portfolio value to fluctuate in real-time during the active period.

15. The method of claim 14, further comprising:
assessing the virtual stock value of the user selection in real-time in the virtual stock market environment based on the raw stock market data aggregated from the actual stock market in real-time to a plurality of virtual stock values of a plurality of user selections received from a plurality of users engaging in the virtual stock market environment; and
determining a virtual stock market value ranking of the user in real-time based on the virtual stock value of the user selection as determined from the raw stock market data aggregated from the actual stock market in real-time relative to the virtual stock values associated with the user received from the users engaging in the virtual stock market environment, wherein the virtual stock value ranking of the user in real-time fluctuates as the raw stock market data aggregated from the actual stock market fluctuates and the virtual stock market values associated with the user selections received from the users fluctuate.

16. The method of claim 15, further comprising:
assessing the virtual portfolio value of the virtual portfolio of the user in real-time in the virtual stock market environment based on the raw stock market data aggregated from the actual stock market in real-time relative to a plurality of virtual portfolio values of a plurality of virtual portfolios associated with the plurality of users engaging in the virtual stock market environment; and
determining a virtual portfolio value ranking of the user in real-time based on the virtual portfolio of the user as determined from the raw stock market data aggregated from the actual stock market in real-time relative to the virtual portfolio values associated with the users engaging in the virtual stock market environment, wherein the virtual portfolio value ranking of the user in real-time fluctuates as the raw stock market data aggregated from the actual stock market fluctuates and the virtual portfolio values associated with the users fluctuate.

17. The method of claim 16, further comprising:
evaluating the virtual portfolio value of the user in real-time to determine a performance record in real-time of the user as the user engages the virtual stock market environment, wherein the performance record of the user depicts a performance of each user selection in the virtual stock market environment as provided by the virtual portfolio value.

18. The method of claim 17, further comprising:
assessing an actual monetary value of the user selection in real-time that corresponds to the actual stock pick into the actual stock market, wherein the actual monetary value is a monetary value of the user selection that the user is to pay an actual stock market broker to engage the user selection into the actual stock market; and
engaging the received user selection that corresponds to the actual stock pick into the actual stock market to simultaneously expose the user selection to a fluctuation in the actual stock market and the fluctuation in the virtual stock market environment that minors the actual stock market in real-time, wherein the user pays the actual monetary value to the actual stock market broker to engage the user selection into the actual stock market.

19. The method of claim 19, further comprising:
evaluating the performance record of the user to determine a performance threshold that the performance record of the user satisfies;
assessing the virtual stock value of the user selection in real-time in the virtual stock market environment relative to a plurality of virtual stock values of a plurality of user selections received from a plurality of users that is positioned in the performance threshold of the user;
assessing the virtual portfolio value of the virtual portfolio of the user in real-time in the virtual stock market environment relative to a plurality of virtual portfolios associated with the plurality of users that is positioned in the performance threshold of the user; and
determining the virtual stock value ranking and the virtual portfolio value ranking of the user in real-time based relative to the plurality of users that is positioned in the performance threshold of the user.

20. The method of claim 19, further comprising:
assessing the actual monetary value of the user selection in real-time that corresponds to the actual stock pick in the actual stock market when the performance record satisfies an actual stock market participation threshold, wherein the actual stock market participation threshold is a threshold that is indicative that the user is capable of engaging the actual stock market with the user selection; and
engaging the received user selection that corresponds to the actual stock pick into the actual stock market to simultaneously expose the user selection to the fluctuation in the actual stock market and the fluctuation in the virtual stock market environment so the user pays the actual monetary value to the actual stock market broker when the performance record satisfies the actual stock market participation threshold.
